(19) United States
(12) Patent Application Publication
(10) Pub. No.: US 2024/0022404 A1
(43) Pub. Date: Jan. 18, 2024

(54) NON-HACKABLE DIGITAL IDENTITY

(71) Applicant: C2 Vault LLC, Dover, DE (US)

(72) Inventors: Tommie Andrè Andreassen Nepstad, Bergen (NO); Jesse Vikjart Erland, Pueblo, CO (US); Melvin James Bullen, Houston, TX (US)

(21) Appl. No.: 18/223,005

(22) Filed: Jul. 17, 2023

Related U.S. Application Data
(60) Provisional application No. 63/389,729, filed on Jul. 15, 2022.

(51) Int. Cl. H04L 9/30; H04L 9/08

(52) U.S. Cl. CPC H04L 9/30; H04L 9/088

(57) ABSTRACT

In accordance with one or more embodiments of the invention, a non-hackable digital identity, including a method of service registration including high resolution digital images of retinas, mapping blood flow, creating arterial and venal circulation system maps, storing the retinal image in memory as a binary large image, consisting of pixels, creating and encrypting a retinal key.

### CROSS-REFERENCE TO RELATED APPLICATIONS

This application claims the benefit of U.S. Provisional Application No. 63/338,729, filed Jul. 15, 2022. The contents of the above-identified application are incorporated by reference in their entirety as if recited in full herein.

### BACKGROUND OF THE INVENTION

### Field of Invention

The inventions disclosed herein generally relate to cryptographic systems, biometrics, encryption algorithms, and blockchain algorithms.

### Description of Related Art

The term “cryptographic system” is abbreviated “cryptosystem” and refers to a computer system that employs cryptography, which is a method of protecting information and communications through the use of codes, so that only those for whom the information is intended can comprehend the information. The term is derived from the Greek word kryptos, which means hidden.

The first known evidence of the use of cryptography in any form was found in an inscription carved around 1900 BC, in the main chamber of the tomb of the nobleman Khnumhotep II, in Egypt.

In 1973, the National Bureau of Standards (now called NIST) in the US put out a request for proposals for a block cipher that was eventually called DES or the Data Encryption Standard. In 1997, and in the following years, DES was broken by an exhaustive search attack due to the small size of the encryption key. As computing power increased it became easy to brute force all different combinations of the key to obtain a possible plain text message. In 1997, NIST again put out a request for proposal for a new block cipher, and in 2000, it was christened AES or the Advanced Encryption Standard.

The secrecy of your message should always depend on the secrecy of the key, and not on the secrecy of the encryption system. This is known as Kerckhoffs's principle.

### BRIEF SUMMARY OF EMBODIMENTS OF THE INVENTION

Aspects of the inventions include a method for service registration comprising capturing a high resolution digital image of a human retina, where the resulting retinal image represents a map of the blood flow to and from the imaged eye; creating mappings of arterial and venal circulation systems based on the captured human retina digital image; storing the retinal image in memory as a binary large object, the binary large object comprising an image consisting of pixels that are either engaged or non-engaged; creating a retinal key from the binary large object, the retinal key having a smaller size than the binary large object, including the steps of: a) mapping graphs of arterial capillary trees from the binary large object using a graph based point matching algorithm known as Graph Transformation Matching to create an arterial system graph map, and creating an attendant set of metadata, the metadata providing data for creating a two-dimensional graphical map from the three-dimensional arterial system, b) mapping graphs of venal capillary trees from the binary large object using a graph based point matching algorithm known as Graph Transformation Matching to create a venal system graph map, and creating an attendant set of metadata, the metadata providing data for creating a two-dimensional graphical map from the three-dimensional venal system and c) measuring geometrical and topological properties of the continuous vascular structure of the binary image in the arterial and venal system graph maps, creating associated metadata, d) creating the retinal key from both the blood vessel graph maps and the metadata combined, e) encrypting the retinal key using one or more dynamic asymmetric encryption algorithms, to produce an encrypted key comprising a static encrypted public key and a dynamic encrypted private key; where the encrypted retinal key requires substantially less data than the binary large object, and substantially uniquely identifies the human retina.

Aspects may also include wherein the binary large object is stored as a bitmap file.

Aspects may include: A method of secure data management within a central bank digital currency (CBDC) ecosystem, comprising e.g. updating account information/personal information/transactional information/account holding/account history/credit scores/receipts; Logging in to a Non-hackable Digital Identity (NDI) system within the CBDC ecosystem for authentication and authorization purposes via a vault's retina scan; Authenticating the user's identity through the NDI system within the CBDC ecosystem; authenticating via the vault's retina scan; Authorizing the user to perform banking transfers and CBDC-related transactions upon successful authentication within the CBDC ecosystem; Receiving encrypted user data via a secure communication channel within the CBDC ecosystem for example, Licenses to Purchase/Sell Data, Receipts, Warranties, Statistical Data, Audit Trail Data, Transaction Data, Analytics and Reporting Data, Compliance and Regulatory Data, Financial Transaction History, Transaction Metadata, User Identity Information, Identity Verification Data; Received by the NDI servers under the users profile and encryption; Unlocking/decrypting/unencrypting the encrypted user data using cryptographic algorithms, e.g. AES, RSA, or ECC, and decryption keys associated with the user's Non-hackable Digital Identity (NDI) within the CBDC ecosystem; Validating the unlocked user-sent data for integrity and authenticity within the CBDC ecosystem using techniques such as digital signatures, hash value verification, or checksum validation; Encrypting specified data using cryptographic algorithms, including AES, RSA, or ECC, and encryption keys associated with the user's NDI within the CBDC ecosystem; Generating an encrypted data package comprising the specified data and associated encryption metadata within the CBDC ecosystem; Transmitting the encrypted data package via a secure communication channel with the CBDC ecosystem, utilizing encrypted messaging protocols, secure APIs, dedicated private networks, or advanced cryptographic mechanisms; Recording data management operations, including banking transfers, CBDC-related transactions, encrypted data transmission, and user identity information, within the transaction ledger of the CBDC ecosystem, encompassing transaction amounts, timestamps, sender and recipient identifiers, encryption metadata, and transaction status; and logging out of the NDI system within the CBDC ecosystem upon completion of data management operations.

### BRIEF DESCRIPTION OF THE DRAWINGS

Embodiments are illustrated by way of example and not by way of limitation in the figures of the accompanying drawings. For a more complete understanding of various embodiments of the present invention, reference is now made to the following descriptions taken in connection with the accompanying drawings in which:

FIG. 1 illustrates the world of biometrics.

FIG. 2 illustrates a caricature of an NDN.

FIG. 3 illustrates the basic data structure of an NDI.

FIG. 4 illustrates the protocol used to register a non-hackable biometric.

FIG. 5 illustrates the method used to perform a service request using a non-hackable biometric.

FIG. 6 illustrates a transaction-spawning example.

FIG. 7 illustrates binary retinal images and the segmentation of their blood vessels.

FIG. 8 illustrates the geometrical and topological properties of the continuous skeleton vascular trees created.

### DETAILED DESCRIPTION OF EMBODIMENTS OF THE INVENTION

In the following detailed description, reference is made to the accompanying drawings, which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

In the description, we use the term non-hackable. Unless we are using a quantum computer with adequate qbits, we must generally use a Turing machine. The term non-hackable is meant to indicate that the amount of time a hacker needs to crack the encryption is a multiple of a normal human life span using a Turing machine. Since technology changes, implementations that must preserve non-hackable elements become dynamic over time. That said, Turing machines are beginning to approach their computational limits, and within several decades their computational power to solve hashes or encryption algorithms will be at its zenith. Non-hackable becomes more static as an algorithm.

In the description, we use the term key. This is meant in a cryptological sense and can be represented as a string of characters used within an encryption algorithm for altering data so that it is not possible to understand it without a decryption key. Like a physical key, a crypto key locks or encrypts data so that only someone with the right key can unlock or decrypt it. In the world of NDIs the key of the present invention is a representation of a retina, e.g. of an animal, e.g. of a human. If the right retina becomes unsuitable then the left may be used. If both eyes become unsuitable then other approaches including genetic testing may work

We use the term NDI to mean non-hackable digital identity. The term NDN means non-hackable digital nomad. DNA means deoxyribonucleic acid. The term hash or cryptographic hash function is a mathematical algorithm that maps data of an arbitrary size to a bit array of a fixed size called the message digest. It is a one-way function.

The NDI is built upon the uniqueness of the human retina blood vessel pattern. Even twins have very different retina patterns. You can become an NDI by registering your retina. Individuals have their retina scanned, rendered into a graph, and turned into a unique retinal key, forming, e.g., a 520 KB message digest using graph metadata. The message digest is encrypted using a public key. This encrypted message digest contains a unique, non-hackable key that can be used to establish a digital identity with permissions among other things. The permissions may be for service providers that enable them to use certain information in order to complete transactions. These transactions can be anything from a debit card purchase, ATM withdrawal, motor vehicle license renewal, non-hackable voting, passport entry, and many others. Non-hackable dynamic asymmetric encryption is used to protect the message digest as it is transmitted to a decentralized customer database. Private keys that open message digests are updated, e.g. every 24 hours.

In the real world, proving your identity may be straightforward. When you show up in person to open a bank account, rent a car, book a hotel room, gamble at a casino or purchase alcohol, you present a government-issued ID, proof of address or whatever else might be required for the transaction, and the company you're doing business with can physically see that you are who you claim to be. This process gets far more complex in the digital world. Now, these same companies must find a way to verify that you are who you say you are, even though you aren't physically there to present your ID or documentation. Companies must find a way to assure your digital identity matches your real-world identity.

A digital identity is the body of information about an individual, group, organization, or electronic device that exists online. Unique identifiers and use patterns make it possible to detect individuals or their devices. Digital identity ensures democratized access to services. In other words, it unlocks a range of essential services now available online, be them financial, healthcare, or educational.

Organizations have a business imperative to care about and verify the digital identities of their users. Three key issues drive this imperative: The first is trust. Your customers and online users trust that you will protect their data. However, there's another side to trust. In many industries, your customers or online users are interacting with one another. Whether a buy-sell-trade exchange, ride-sharing, social media, dating site or other online platform, trust is the linchpin of it all, and the foundation of trust is establishing that the person on the other end of the transaction is who they say they are. In fact, a recent study showed that two-thirds of consumers would be more likely to engage with a financial services business if it has robust identity verification. It also found that 83% of consumers think it is important for social media sites to verify identities to hold users accountable.

The second is fraud risk. The increasing array of identity information housed online is leading to a growing risk that this information will fall into the hands of fraudsters. This fraud does not just hit your customers in the pocketbook merchant losses to online payment fraud will exceed $206 billion cumulatively for the period between 2021 and 2025, according to Juniper Research.

The third is compliance. Existing and evolving compliance mandates bring digital identity to the forefront of the minds of compliance managers and executives. KYC and AML compliance mandates are probably the most well known when it comes to their direct impact on online processes, especially account opening. But there are others, including California's CCPA compliance rules and Europe's GDPR (General Data Protection Regulation) mandates that are driving the need for companies to establish a strong link between digital and real-world identities of their online customers.

Digital nomads are people who conduct their life in a nomadic manner while engaging in remote work using the Internet. Such people generally have minimal material possessions and work remotely in temporary housing, hotels, cafes, public libraries, co-working spaces, or recreational vehicles, using WiFi, smartphones, or mobile hotspots to access the Internet. Some digital nomads are perpetual travelers, while others are only nomadic for a short period. While some nomads travel through various countries, others focus on one area. Some may engage in van dwelling. In 2020, a research study found that 10.9 million American workers described themselves as digital nomads, an increase of 49% from 2019.

Some digital nomads today have non-hackable digital identities. They manage this by safeguarding ledgers, or taking other complex measures to make their identity not accessible. These cases represent methods available in cryptosphere 1.0 permit a non-hackable digital nomad (NDN). In cryptosphere 2.0 a fully functional NDN employs a non-hackable biometric, thus enabling new applications. The rise of a fully functional NDN, which is truly autonomous and non-hackable, is a major advance for cryptographic systems, and demonstrates the power of cryptosphere 2.0; and its creation of true NDIs who in turn enable true NDNs.

We may describe the database in a simplistic sense, and we may define the communications interface necessary to query the database. It may be operated as middleware as an open source platform. The blockchain technology used may be a type of proof of stake, proof of creation, or related chains, which has all of the attributes required, but without the energy price tag of a proof of work blockchain such as Bitcoin.

The invention may include a waterproof apparatus, capable of high resolution digital images of the human retina, building an, e.g., 520 kilobyte message digest from a graph of the retina, and metadata from the graph as the retinal key by algorithm. The message digest may be safeguarded by using dynamic asymmetric encryption, e.g. with the 1024 byte private key changing every 24 hours. In some cases, electrical power may be drawn solely from a USB 3.0 cable, or similar, where an, e.g. 32 bit unique physical identity is stored in ROM, and gigabytes of RAM are available for user files, forming the basis for a non-hackable biometric. Service registration may be provided for, service registration comprising: a non-hackable biometric itself made non-hackable and communicated over the Internet. A service request may be processed, the service request comprising a non-hackable biometric itself made non-hackable and paired with a service request message communicated over the Internet. A customer may register their non-hackable biometric, and constructs personal information. A customer may register their non-hackable biometric, and construct permissions authorizations for use in processing service requests. The systems and methods may include where a customer enables transactions to be processed based upon personal information uploaded and enabled permissions to use the personal information. The inventions may use with personal information comprising one or more of: anonymous and non-hackable content; biometrics, vital statistics, vital records, medical records, citizenship records, financial information, communications, physical address, black list, white list, beneficiary assignment, drivers license information, passport information, and other such information necessary to complete a digital identity. A biometric may include a retinal scan. A biometric may be genomic. Relevant personal information may comprise: links to physical devices where redundant personal information may be stored offline. Relevant personal information may comprise: links to physical devices where new personal information is stored offline. Service requests may be encrypted. Allow lists or white list of message digests may have certain permissions. Block lists or black list of message digests may be denied certain permissions.

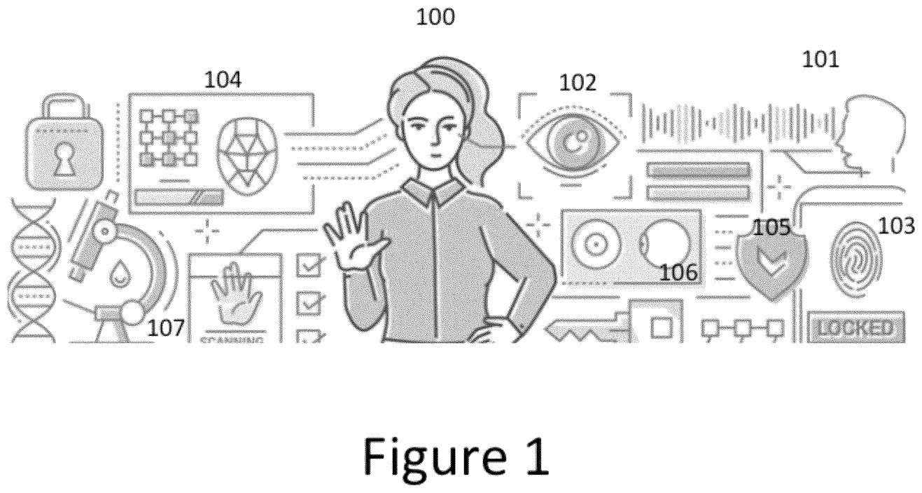

FIG. 1 shows a woman 100 who has just had her retina scanned. For her, this opens up the world of FIG. 1 because the woman 100 has a secure non-hackable digital identity. The retinal scan 102 may have one false positive in 10 to the 78th attempts, which is exceedingly non-hackable. The figure shows a voiceprint 101, the fingerprint 103, and facial recognition 104. Shown here are the law enforcement industry 105, industrial research 106, and the pharmaceutical industry 107. Many others are possible.

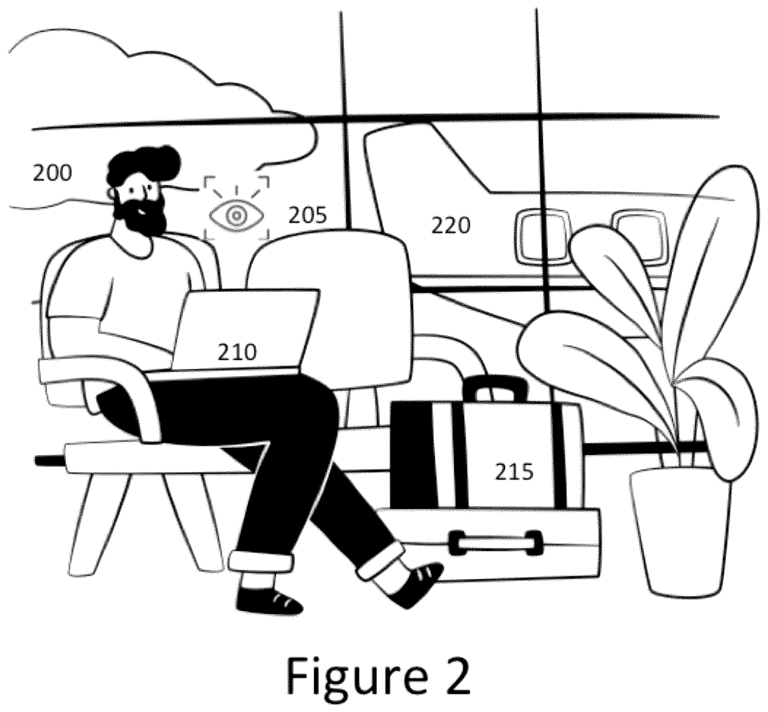

FIG. 2 shows a non-hackable digital nomad (NDN) 200. The NDN is able to exist because of the retinal scanner 205, which provides a non-hackable key to their digital identity. Surrounding the NDN 200 are the typical trappings of an NDN. A computer 210, suitcases 215 as our NDNs allegedly are nomadic with an airplane 220 nearby for ease of nomadic lifestyle. The reality is we simply won't know.

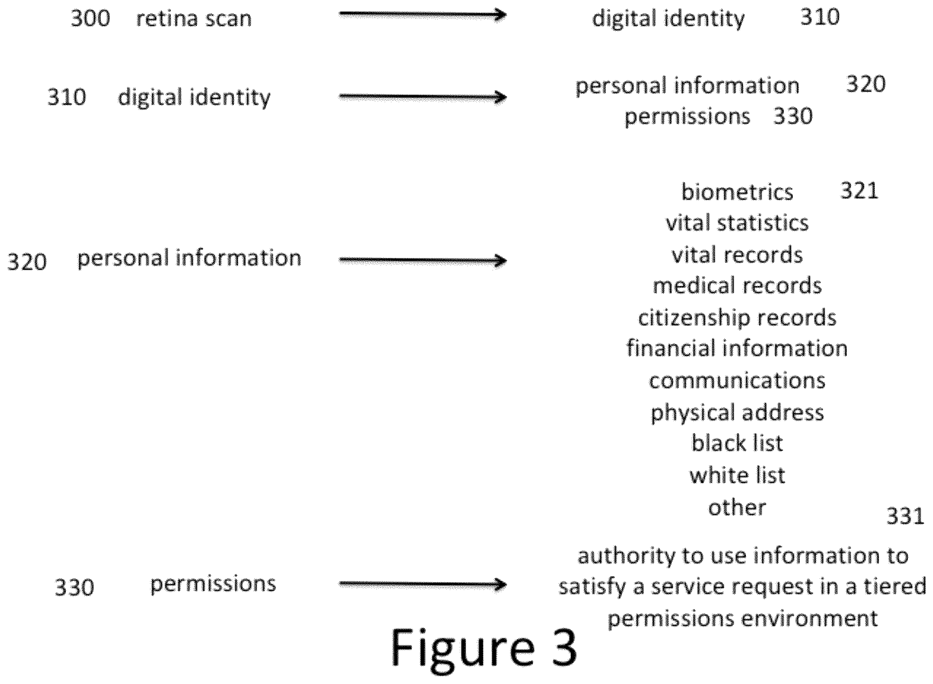

FIG. 3 shows the basic data structure of an NDI. The retina scan 300 opens up the digital identity 310. This digital identity 310 contains personal information 320 and permissions 330. The personal information 320 contains many different kinds of information. This is illustrated in 321. The personal information elements in 321 are biometrics, which may include fingerprint, EM field, facial scan, gate analysis, iris scan, retinal scan, and genomics. The vital statistics represents who you are right now, and vital records, plus medical records back that up. There are citizenship records kept so voter fraud is impossible. There is financial information, which details debit or credit cards, bank account information, assets, etc. It will contain your physical address, and how to communicate with you. There is a black list of hashed retinal keys (message digest), which represents NDIs that are not trusted, and there is a corresponding white list of hashed retinal key (message digest), which represents NDIs that are trusted. The most important part of FIG. 3 is the permissions 330. Essentially the permissions represent the authority to use personal information in a service request. The customer will need to establish 331, which represents what information is actually available for a service transaction. The tiered permissions environment means having certain permissions enable entire other permissions. Anyway the user's information may legally be used to satisfy a service request, and then it shall be. Some permissions enable other permissions; just as permission denials may beget other denials. Note these transactions may be anything from a DMV renewal, a Passport renewal, or getting cash from an ATM.

Hashing is the process of generating a value from a text or a list of numbers using a mathematical function known as an hash function. A hash function is a function that converts a given numeric or alphanumeric key to a small practical integer value. The mapped integer value is used as an index in the hash table. SHA-1 or Secure Hash Algorithm 1 is a cryptographic hash function, which takes an input and produces a 160-bit (20-byte) hash value. This hash value is known as a message digest. This message digest is usually then rendered as a hexadecimal number, which is 40 digits long. It was designed by the United States National Security Agency (NSA), and is a U.S. Federal Information Processing Standard (FIPS). Since 2005, SHA-1 has not been considered secure against attacks; as of 2010 many organizations have recommended its replacement. The National Institute of Standards and Technology (NIST) formally deprecated use of SHA-1 in 2011 and disallowed its use for digital signatures in 2013. As of 2020, chosen-prefix attacks against SHA-1 are the preferred hacking approach. Replacing SHA-1 is urgent where it is used for digital signatures.

SHA-2 (Secure Hash Algorithm 2) is a set of cryptographic hash functions designed by the United States National Security Agency (NSA) and first published in 2001. They are built using the Merkle-Damgird construction, from a one-way compression function itself built using the Davies-Meyer structure from a specialized block cipher. SHA-2 includes significant changes from its predecessor, SHA-1. The SHA-2 family consists of six hash functions with digests (hash values) that are 224, 256, 384 or 512 bits: SHA-224, SHA-256, SHA-384, SHA-512, SHA-512/224, and SHA-512/256. SHA-256 and SHA-512 are novel hash functions computed with eight 32-bit and 64-bit words, respectively. They use different shift amounts and additive constants, but their structures are otherwise virtually identical, differing only in the number of rounds. SHA-224 and SHA-384 are truncated versions of SHA-256 and SHA-512 respectively, computed with different initial values. SHA-512/224 and SHA-512/256 are also truncated versions of SHA-512, but the initial values are generated using the method described in Federal Information Processing Standards (FIPS) PUB 180-4. SHA-2 was first published by NIST as a U.S. federal standard (FIPS). The SHA-2 families of algorithms are patented in the US. The United States has released the patent under a royalty-free license. As of 2011, the best public attacks break preimage resistance for 52 out of 64 rounds of SHA-256 or 57 out of 80 rounds of SHA-512, and collision resistance for 46 out of 64 rounds of SHA-256. As of this filing in 2022, SHA-256 has not been cracked.

In 2012 the NIST hash function competition selected a new hash algorithm, SHA-3. The SHA-3 algorithm is not derived from SHA-2. While SHA-3 does not specify a hash with security above 256-bits, it does specify an extendable output function SHAKE256; SHAKE means a secure hashing algorithm—extendable output, which is a function with variable length outputs starting out at 256-bit internal security (SHAKE256), and ending at 1024-bit internal security (SHAKE1024). From this range we select SHAKE1024. The digest is 1024 bits or 16 64-bit words. SHAKE1024 has the effective security of a 512-bit hash.

We use the term POS to mean proof of stake; we use the term POCR to mean Proof Of Creation. We use the term POID to mean Proof Of Identity. We use the term DPOS to mean delegated proof of stake. Proof-of-stake is a cryptocurrency consensus mechanism for processing transactions and creating new blocks in a blockchain. A consensus mechanism is a method for validating entries into a distributed database and keeping the database secure. The term ATM refers to an automated teller machine. USB mean universal serial bus. The term ROM means read only memory.

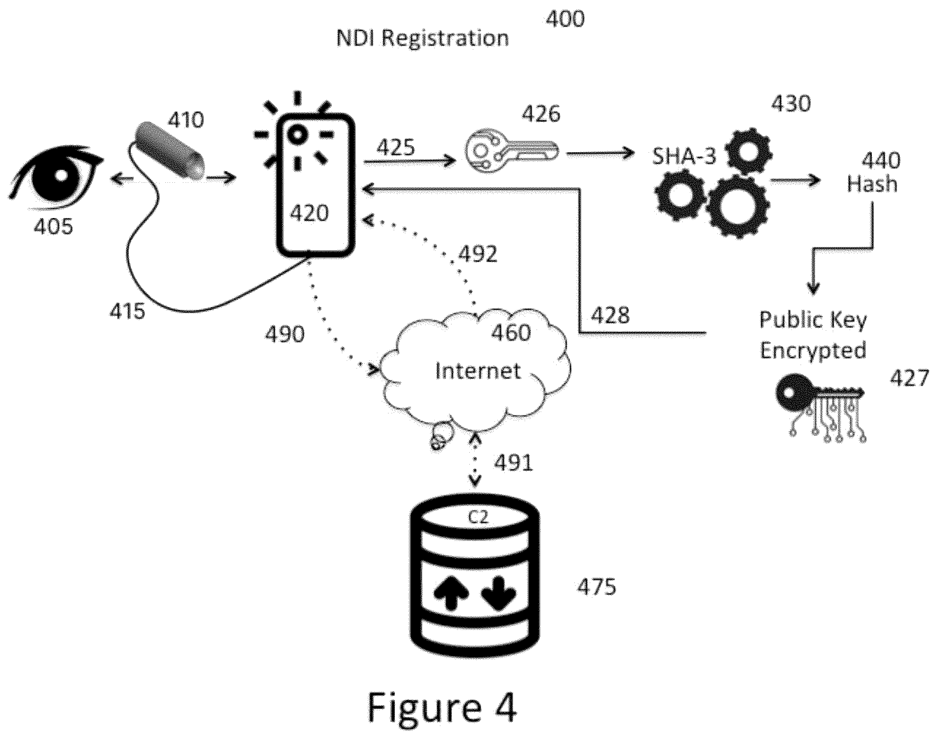

FIG. 4 shows us NDI registration in 400. A specialized device 410 with a suitable camera images the customer's retina shown 405. The device, 410 (also known as a Vault) is connected to a thin client application running on 420 using at USB 3.0 cable shown 415. The retinal image from 420 has its blood vessels graphed 425, and this graph along with graphic metadata is used as the retinal key 426, and is comprised of, e.g., up to 520 kilobytes. This is also called the message digest. The process of creating the message digest is comprised of 2 important steps. The first is the segmentation of blood vessels to generate a binary image, and second the analysis of the binary image. Features of interest are branching and crossing points as feature details for mosaicing, and the extraction of arterial and venous blood vessel trees for characterization. An automated method is used to measure geometrical and topological properties of the continuous vascular structure on the retinal image. We can then use this data for graph transformation matching to determine if this retinal image matches the retinal image stored when the customer registered their retina.

This message digest is encrypted with a public key 427. This is returned to 420 shown by 428. Once encrypted control is returned to 420 where it can finish the request for registration and send it, shown by line 490 sending the registration using the Internet 460 over 491 to the C2 database 475. The database registers the request and sends a confirmation using the Internet 460 over 491 and then 492 where the confirmation is displayed on the device 420. There's no requirement the device 420 is actually a mobile phone. It may be another device such as a tablet or computer.

The transmission of information along 490, 491, and 492 are protected by dynamic asymmetric encryption, or public/private key encryption. 475 transmits a public key to device 420. The dynamic asymmetric encryption is non-hackable, as the private key is changed, for example every 24 hours, or more or less frequently, e.g. every 1, 2, 4, 8, 12, 24, 48 or 168 hours, by way of nonlimiting examples.

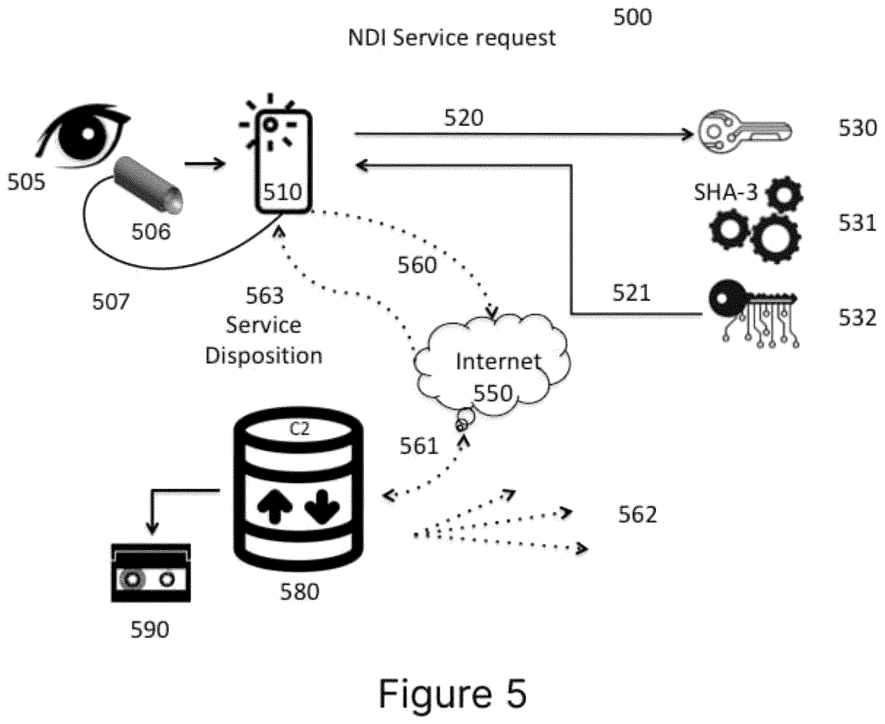

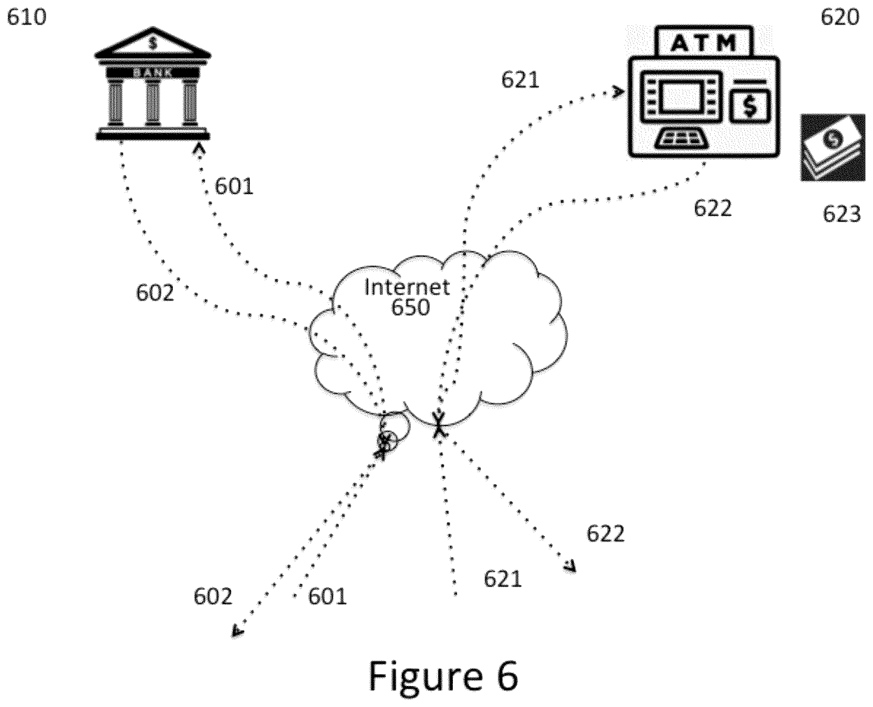

FIG. 5 shows an NDI service request 500. The customer's eye 505 has a retina imaged by device 506. This device is connected to a thin client application running on 510, by a USB 3.0 cable, shown 507. This image is turned into a retinal key 530 by an algorithm 520. This message digest 531 is then encrypted using a public key 532 and finally returned to 510 as shown in line 521. At this point the application in 510 pairs the encrypted message digest with a service request. This service request discloses billing information and service type. The device 510 sends the message digest and service request to database 580 via the Internet 550 using lines 560 and 561. The database 580 evaluates the customer's permissions and if approved works the service request by spawning transactions 562. 562 refers us to FIG. 6. If the customer was withdrawing cash from an ATM then the spawned transactions may be a withdrawal from a bank account, and instructions for an ATM to release cash to the customer. Once the spawned transactions complete, the database 580 sends a service disposition (receipt) via the Internet 550 shown in lines 561 and 563.

The database 580 keeps track of all transactions in a shared, immutable ledger that records transactions in a business network. This is shown as 590, and represents transaction logs spooling onto a system that is much faster at writing transactions than the service request transaction arrival rate. We refer to this as C2chain. C2chain is a system in which a record of transactions made is maintained across several computers that are linked in a peer-to-peer network. It is inspectable and searchable, yet does not have the major disadvantage of Bitcoin's blockchain, which is excessive energy spent by miners to validate a transaction. C2chain is a proof-of-creation methodology that reduces the amount of computational work needed to verify blocks and transactions that keep the blockchain, and thus a cryptocurrency, secure.

The transmission points 560, 561, and 563 are protected using dynamic asymmetric encryption. Database 580 transmits a public key to device 510. The spawned transactions 562 may require encryption, and the edge service provider will likely drive that encryption, if any.

FIG. 6 shows the transaction infrastructure spawned from FIG. 5. The bank transaction 601 traverses the Internet 650 and is processed by a bank 610. The transaction is approved and returned 602, which also traverses the Internet 650. This in turn spawns transaction 621, which traverses the Internet 650 to an ATM machine 620. The cash 623 is output the ATM machine, and a notification of completion sent out 622. The eyeball 505 of FIG. 5 sees the cash 623 and does whatever with it. The transmissions 601 and 621 require encryption. 602 and 622, which return transaction receipts may or may not require encryption depending on the service provider. In this example, 602 is the return transaction receipt of a funds withdrawal. The account information must be redacted if the transaction receipt is not encrypted. In 622 the transaction receipt of funds provided must also have account information redacted or the receipt encrypted.

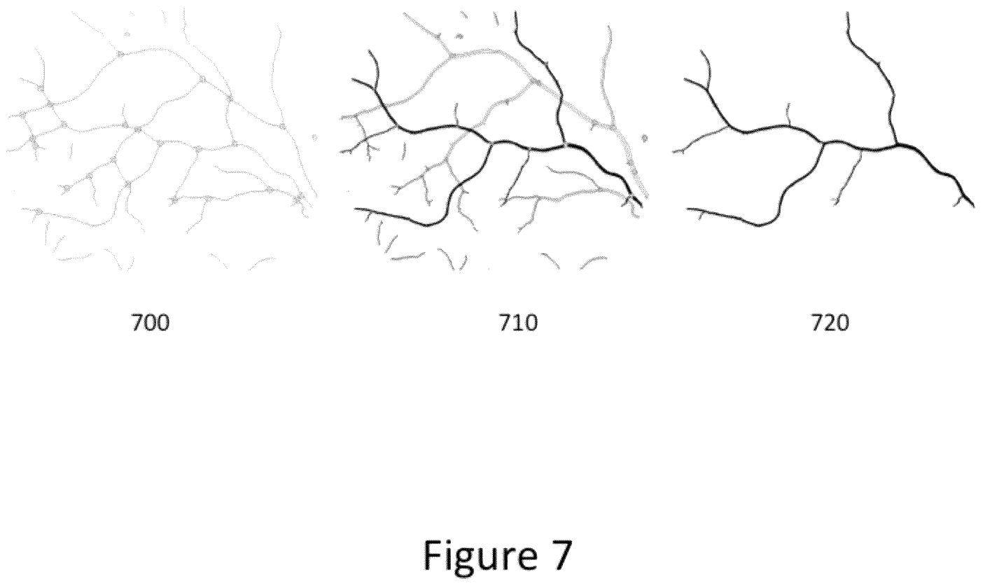

FIG. 7 illustrates binary retinal images and the segmentation of their blood vessels. Image feature extraction consists of two main steps: 1) the segmentation of blood vessels to generate a binary image, and 2) the analysis of the binary image. The necessary features are the branching and crossing points and extraction of arterial and venous vessel trees for characterization. Blood vessels are segmented based on analysis of the first and second derivatives of the binary images in combination with a region growing algorithm. FIG. 7 illustrates binary views of a retinal image. 710 illustrates two different binary views of the same retinal image. FIG. 7 illustrates in 700 and 720 their segmented binary images, respectively. The optic disc region is on the bottom-right, and vessels are tracked from this area outwards. An exemplary region growing algorithm is shown in M. E. Martinez-Perez, A. D. Hughes, S. A. Thom, A. A. Bharath, and K. H. Parker. Segmentation of blood vessels from red-free and fluorescein retinal images. Medical Image Analysis, 11(1):47 61, 2007.

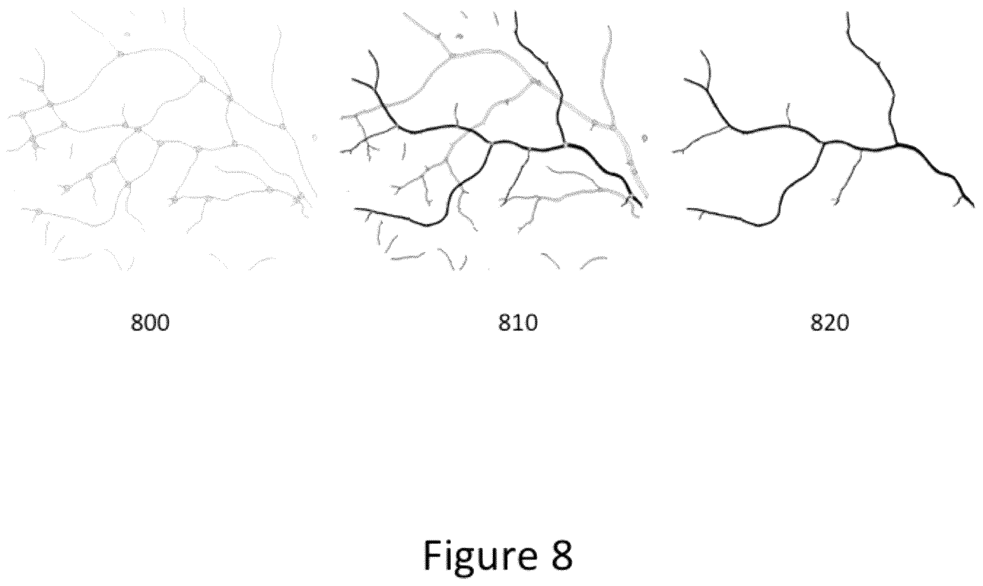

FIG. 8 illustrates the geometrical and topological properties of the continuous skeleton vascular trees created. In FIG. 8 we see the labelling of the vessel tree as this involves thinning the segmented binary image to produce its skeleton 800. Three types of significant points in the skeleton must be detected. These are the terminal, bifurcation and crossing points. In a first pass, skeleton pixels with only one neighbor in, e.g., a 3 by 3 neighborhood are labelled as terminal points and pixels with 3 neighbors are labelled as candidate bifurcation points. These points are shown in 800 marked with circles. Because vessel crossing points appear in the skeleton as two bifurcation points very close to each other, a second pass is made using a smaller size window centered on the candidate bifurcations. The number of intersections of the skeleton with the window frame determine whether the point is a bifurcation or a crossing. After this process a chain code is used to label the rest of the skeleton points. FIG. 8, 810 shows the branching and crossing points marked with circles over the skeleton and the tree is shown in black. In 820 we see an arterial tree extracted. The venal tree is extracted in an identical manner.

Re an algorithm to take the binary large object (BLOB) that is a digital image of a human retina and create a retinal key, our choice of algorithm is to recognize trees (graphs) of the arterial and venal capillaries, preserving the uniqueness, while creating a key that in size is preferably no longer a BLOB (problematic due to its size). It is unwieldy to utilize in databases, through networks, and so forth. We apply a point matching method which is a member of a class of algorithms that utilize graph transformation matching (GTM) techniques. Ophthalmic research has utilized imaging the human retina for diagnostic purposes over time such as congestive heart failure, atherosclerosis, cholesterol issues, and also appear in the eyes. Recently, disease has begun to be identified using one retinal image; communicable illnesses such as AIDS, syphilis, malaria, chicken pox and hereditary diseases like leukemia, lymphoma, and further still sickle cell anemia, or is pregnant all affects the eyes. In summary: The algorithm was selected to both shrink the BLOB down to manageable size and to preserve uniqueness. The preservation of uniqueness is achieved by mapping the arterial and venal capillary trees. This is done through the extraction of image features from the BLOB, and additional machinations described herein. The algorithm both compresses the BLOB, and preserve uniqueness. When we use the capillary trees (arterial and venal) we accomplish both objectives. A binary large object may be stored as a bitmap file, where bitmap is a type of image file format used to store digital images.

A retinal image may be stored in memory, e.g. as a binary large object, the binary large object comprising an image consisting of pixels that are either black or white. Black or white pixels may refer to non-engaged or engaged pixels. I.e. there may be a binary state for a pixel, and the two states of the pixel could be referred to as black or white, or non-engaged or engaged, or other descriptors for these two states.

The usage of an encrypted non-hackable biometric over a network is a powerful tool for authentication. The owner of the retinal key has ‘permissions’ which allow transactions to take place according to personal settings. When used with a registration service you create the ultimate ‘know your customer’ application. This enables total secrecy of digital identity where individual permissions determine transaction outcomes.

An example of a registration service is web3. A user wanting to go to web3, can request credentials (good for some time) that they are authentic (who they say they are) by using their retina. C2vault provides registration service on the blockchain and provide you with the credentials mentioned above. User asks C2vault for credentials, C2vault provides them. User goes to web3 and gives web3 credentials. web3 asks C2vault if the credentials are valid and we agree, and the user is set loose in the web3 domain. The same could be done for Twitter, or any social media platform. It can obviously be used in crypto. In fact, it is the ultimate KYC system (know your customer). Amazon, banks, Alibaba, DMV, vote, etc.

Transformation of a digital retinal image to a retinal key enable a non-hackable digital identity. Retinal images have been used for ophthalmological reasons for 2 decades, and the analysis of binary retinal images including GTM and other algorithms. Up to this point human biometrics (except genomics) are all subject to being hacked. Fingerprints, facial recognition, iris scan are examples of biometrics that are easily falsified. This is not the case with a digital picture of a retina, and this provides an opportunity to eliminate the systemic fraud in the cryptosphere through the possession of a digital identity that cannot be hacked.

Confirmation of your digital identity based upon a previous registration of retinal key. Once you have registered your retinal key, you create and process transactions based upon your registration proving that you are in fact who you say you are. This makes it very difficult for automated programs (bots) to function as they do not have a retina. And it is only possible to reuse a Vault for a different registration/transference of Vault ownership via permissions set by only the original retina registrant. If these permissions are not previously set by the original retinal registrant, the Vault becomes blacklisted/useless for any secondary user. Here, the identity to prove who you are is not hackable. Only you have your retina.

The device registering your retinal key may have a unique, e.g. 32 bit identification. In order to provide the security to close the loop (as it were) is that each Vault is unique. It preferably has a unique 32 bit number assigned to it. If any retinal key besides the original/registered/permissioned retinal key tries to use the Vault, it may be blacklisted.

Use of the NDI in a ‘know your customer’ system. Today we do not have a know your customer (KYC) system today that cannot be hacked. The introduction of a non-hackable KYC will revolutionize the cryptosphere by decreasing fraud, friction (difficulty), and the frustration inherent in current hackable KYC. Everyone has experienced a KYC system anytime they go to a bank, go to the Department of Motor Vehicles, and so forth. The experience with a Vault we expect to be transformational.

Use of dynamic asymmetric encryption (DAE) to preserve non-hackability when using the retinal key. It is not enough to create the retinal key and move it around via the Internet. We need to keep that information private and secure and to do that we use dynamic asymmetric encryption. We preferably use a 1024 bit private key that is rotated, e.g., every 24 hours, or more or less often. The use of DAE and the retinal key completes the necessary process for non-hackability.

Elliptic Curve Cryptography (ECC), as the name implies, is an asymmetric encryption algorithm that employs the algebraic architecture of elliptic curves with finite fields.

User controller permissions governing how personal information may be utilized for any transaction. People that register their retinal key also provide a set of permissions that are enabled or disabled depending on the context of the transaction. For example: a bank transaction may require name, address, and bank account information. This would be given for a bank transaction, but not navigating to a social media site.

A charge-coupled device (CCD) is a light-sensitive integrated circuit, that captures images by converting light (photon) to electrons. The CCD sensor breaks the image elements into discreet elements, called pixels. Each pixel is converted into an electrical charge whose intensity, is related to the intensity of light captured by that pixel. CCD technology was invented in 1969. It is very efficient today.

The Ophthalmic community has been using digital images to extract arterial and venal trees (graphs), in the pursuit of diagnosis of various diseases.

The message digest is a bit of a hold over from something earlier that encrypted, yet further the retinal key. So it is interchangeable with retinal key. This is then encrypted using dynamic asymmetric encryption (e.g. changed every 24 hours) and is moved over the USB or other mechanism to a thin client (e.g. mobile, computer, etc.).

GTM algorithms. Graph Transformation Matching (GTM) has applications in flow networks, scheduling and planning, modeling bonds in chemistry, graph coloring, the stable marriage problem, neural networks in artificial intelligence, traffic networks, navigable networks, optimal routing for emergency response, vascular characterization in ophthalmology, and graph-theoretic approaches to molecular epidemiology. Examples of exemplary applications are Google's Page Rank and Netflix Content Recommendation.

Metadata. Three kinds of metadata are described. Descriptive, structural, and administrative. Descriptive metadata is identification information for the resource. Examples of descriptive metadata for a document include the title and creator's name. Structural metadata provides information about how the elements of the resource or data are organized and related. A YouTube video's structural metadata might include the different parts of the video, what order they're arranged in, and where ads play. Administrative metadata is information about the origin of a resource, who owns the data, and who can access it. The administrative metadata of a photo might include the copyright owner, the camera equipment used, the shutter speed, and the image resolution.

For the retinal image the metadata is preferably completely structural. The creation of the arterial map, venal map, and metadata involves image feature extraction. An algorithm called chain-code tracking to perform this, involves thinning each vessel tree (arterial and venal), detecting significant points (crossing, branching, bifurcation, etc.). Extracting the vessel tree by a chain-code tracking algorithm and storing geometrical and topological parameters. This algorithm, chain-code tracking is based on identifying and storing the directions from each pixel to its neighbor pixel on each contour. It is a lossless algorithm, which is important. This step preserves the unique nature of any given retina. Before defining this process, it is necessary to clarify the various types of neighbors that are associated with a given pixel in a binary image. In our case there are only 8 directions possible, so we use a simple 8-neighbor direction code (up, down, left, right, upper left, upper right, lower left, and lower right).

This process thins out, the now segmented binary image to produce an accurate map or skeleton of the arterial or venal blood flow system. Three types of points matter; terminal, bifurcation, and crossing. In the algorithm's first pass skeleton pixels with only 1 neighbor in a 3×3 neighborhood are labeled as terminal and pixels with 3 neighbors are labeled as candidates for bifurcation. Crossing points show up as 2 bifurcation points, so a second pass is made through the data using a fixed size window centered on the candidate bifurcations. The number of intersections of the skeleton with the fixed window determine if it is a bifurcation or crossing. After this process a chain code is used to produce a very accurate map of the venal and arterial blood supply. And along the way has collected metadata about each.

The service registration of an arterial map, venal map, plus their metadata are used to determine if an image presented may be authenticated. To do so we use an algorithm called ‘Image hashes’ which tells whether two images look nearly identical. This is different from cryptographic hashing algorithms (like MD or SHA-1) where tiny changes in the image give completely different hashes. In image fingerprinting, we actually want our similar inputs to have similar output hashes as well. Imagehash is a python program with source hosted at GitHub: https://github.com/JohannesBuchner/imagehash. This code may be rewritten, e.g. in C, for performance reasons.

There are many image hashing instances: Average hashing (aHashref), Perceptual hashing (pHashref), Difference hashing (dHashref), Wavelet hashing (wHashref), and Crop-resistant hashing (crop resistant hashref). The methods preferably use dHashref or difference hashing. dHashref is exactly needed to compare a registration dataset, and a validate me dataset. It will generate a close to zero response all the time, if these are different images of the same retina, unless there is disease or injury to the eye.

Retinal Key. The term retinal key means a segmented data set that contains an arterial map, a venal map, and attendant metadata of each. This segmented file is the Retinal Key. The first 2 segments (arterial and venal map) are image hashed (e.g. dHashref) against the registered arterial and venal maps. The metadata of each map is also analyzed to make a determination if the dHashref score is not low.

Genomic biometric information. Single Nucleotide Polymorphisms (SNPs): These are genetic variations that involve a single base pair change in the DNA sequence. SNPs can be used to create a unique genetic profile for an individual. Short Tandem Repeats (STRs): STRs are regions of DNA where a short sequence of nucleotides is repeated multiple times. The number of repeats can vary between individuals and can be used as a distinctive identifier. Mitochondrial DNA (mtDNA): mtDNA is genetic material present in mitochondria, and it is inherited from the maternal lineage. Analysis of mtDNA sequences can provide information about an individual's maternal ancestry. Haplotypes: A haplotype is a set of genetic markers that tend to be inherited together. It can be used to determine an individual's genetic profile and assess relatedness to others. Genomic variants: This category includes various types of genetic variations, such as insertions, deletions, duplications, and structural rearrangements in the DNA sequence. These variants can be unique to an individual and can serve as identifiers.

AES (Advanced Encryption Standard): AES is a symmetric encryption algorithm widely used for securing sensitive data. It operates on fixed-size blocks of data and supports different key lengths, such as AES-128, AES-192, and AES-256. AES is known for its efficiency and strong security. RSA (Rivest-Shamir-Adleman): RSA is an asymmetric encryption algorithm that uses a pair of keys: a public key for encryption and a private key for decryption. It is based on the mathematical difficulty of factoring large prime numbers. RSA is often used for key exchange, digital signatures, and secure communication. ECC (Elliptic Curve Cryptography): ECC is an asymmetric encryption algorithm that uses the mathematics of elliptic curves. It provides the same level of security as traditional asymmetric algorithms (such as RSA) but with shorter key lengths, making it computationally efficient. ECC is commonly used in resource-constrained environments like mobile devices.

As will be realized, the systems and methods disclosed herein are capable of other and different embodiments and its several details may be capable of modifications in various respects, all without departing from the invention as set out in the appended claims. Accordingly, the drawings and description are to be regarded as illustrative in nature and not in a restrictive or limiting sense with the scope of the application being indicated in the claims.

What is claimed is:

1. A method for service registration comprising:
capturing a high resolution digital image of a human retina, where the resulting retinal image represents a map of the blood flow to and from the imaged eye;
creating mappings of arterial and venal circulation systems based on the captured human retina digital image;
storing the retinal image in memory as a binary large object, the binary large object comprising an image consisting of pixels that are either engaged or non-engaged;
creating a retinal key from the binary large object, the retinal key having a smaller size than the binary large object, including the steps of: a) mapping graphs of arterial capillary trees from the binary large object using a graph based point matching algorithm known as Graph Transformation Matching to create an arterial system graph map, and creating an attendant set of metadata, the metadata providing data for creating a two-dimensional graphical map from the three-dimensional arterial system, b) mapping graphs of venal capillary trees from the binary large object using a graph based point matching algorithm known as Graph Transformation Matching to create a venal system graph map, and creating an attendant set of metadata, the metadata providing data for creating a two-dimensional graphical map from the three-dimensional venal system and c) measuring geometrical and topological properties of the continuous vascular structure of the binary image in the arterial and venal system graph maps, creating associated metadata, d) creating the retinal key from both the blood vessel graph maps and the metadata combined, e) encrypting the retinal key using one or more asymmetric encryption algorithms, to produce an encrypted key comprising an asymmetric encrypted public/private key pair;
where the encrypted retinal key requires substantially less data than the binary large object, and substantially uniquely identifies the human retina.

2. The method of service registration of claim 1, wherein the binary large object is stored as a bitmap file.

3. The method of service registration of claim 1, where the service registration message is communicated over the internet.

4. The method of service registration of claim 1, where a user registers their non-hackable biometric hash, and constructs personal information.

5. The method of service registration of claim 1, where a user registers their non-hackable biometric hash, and constructs permission authorizations for use in processing service requests.

6. The method of service registration of claim 1, where a user enables transactions to be processed based upon both personal information uploaded and enabled permissions to use the personal information.

7. The method of service registration of claim 6, where the personal information comprises one or more of: anonymous and non-hackable content; biometrics; vital statistics; vital records; medical records; citizenship records; financial information; communications; physical address; block list; allow list; beneficiary assignment; drivers license information; passport information; other information necessary to complete a digital identity.

8. The method of service registration of claim 1, further including genomic biometric information, the genomic biometric information comprising at least one of: a) Single nucleotide polymorphisms (SNPs), representing genetic variations involving single base pair changes; b) Short tandem repeats (STRs), denoting regions of DNA with repeated short sequences; c) Mitochondrial DNA (mtDNA), referring to genetic material inherited from the maternal lineage; d) Haplotypes, indicating sets of genetic markers inherited together; and e) Genomic variants, encompassing various types of genetic variations, including insertions, deletions, duplications, and structural rearrangements.

9. The method of service registration of claim 6, wherein personal information includes links to physical devices where redundant personal information may be stored offline.

10. The method of service registration of claim 6, wherein personal information includes links to physical devices where new personal information may be stored offline.

11. The method of service registration of claim 1, utilizing blockchain technology, where the blockchain technology includes one or more of: Proof of Work (PoW); Proof of Stake (PoS); Delegated Proof of Stake (DPoS); Practical Byzantine Fault Tolerance (PBFT); Federated Byzantine Agreement (FBA); Directed Acyclic Graph (DAG); Proof of Authority (PoA); Proof of Elapsed Time (PoET); Proof of Burn (PoB); Proof of creation (POCR); Proof of Capacity (PoC); Proof of Importance (PoI); Proof of Identity (PoID); Proof of Activity (PoA); Proof of Weight (PoWeight); Proof of Reputation (PoR); Proof of Space-Time (PoST); Synchronized Proof of Stake (SPoS); Tendermint Consensus; Raft Consensus; and Avalanche Consensus.

12. The method of service registration of claim 1, wherein the service request is encrypted.

13. The method of service registration of claim 1, further comprising an allow list of message digests with permissions.

14. The method of service registration of claim 1, further comprising a block list of message digests denying permissions.

15. The method of service registration of claim 1, including a SHA-3 hashing algorithm.

16. A method of secure data management within a central bank digital currency (CBDC) ecosystem, the method comprising:
logging a user into a Non-hackable Digital Identity (NDI) system within the CBDC ecosystem for authentication and authorization purposes using a vault device retina scan;
authenticating the identity of the user logging in to the NDI system within the CBDC ecosystem, where the authenticating is done via vault's retina scan;
authorizing the user to perform one or more of banking transfers and CBDC-related transactions, upon successful authentication within the CBDC ecosystem;
receiving encrypted user data via a secure communication channel within the CBDC ecosystem;
receiving via NDI servers the users profile and encryption data;
decrypting the encrypted user data using at least one of the following cryptographic algorithms: AES (Advanced Encryption Standard); RSA (Rivest-Shamir-Adleman);
and ECC (Elliptic Curve Cryptography), and using encryption keys associated with the user's NDI within the CBDC ecosystem;
and generating an encrypted data package comprising the specified data and associated encryption metadata within the CBDC ecosystem.

17. The method of claim 16, further comprising: transmitting the encrypted data package via a secure communication channel with the CBDC ecosystem, utilizing one or more of: an encrypted messaging protocol; a secure API; and a dedicated private network; recording data management operations; and logging the user out of the NDI system within the CBDB ecosystem.

18. The method of claim 17, wherein the recorded data management operations include one or more of: banking transfers, CBDC-related transactions, encrypted data transmission, user identity information within the transaction ledger of the CBDC ecosystem, transaction amounts, timestamps, sender and recipient identifiers, encryption metadata, and transaction status.

19. The method of claim 16, wherein secure data management comprises at least one of: updating account information; updating personal information; updating transactional information; updating account holdings; updating account history; updating one or more credit scores; and updating receipts.

20. The method of claim 16, where the received encrypted user data includes one or more of: licenses to purchase/sell data, receipts, warranties, statistical data, audit trail data, transaction data, analytics and reporting data, compliance and regulatory data, financial transaction history, transaction metadata, user identity information, and identity verification data.
